(19) United States
(12) Patent Application Publication
(10) Pub. No.: US 2026/0134856 A1
(43) Pub. Date: May 14, 2026

(54) DEVICES, SYSTEMS, AND METHODS FOR RECORDING AND/OR SHARING USER-GENERATED MUSIC CONTENT

(71) Applicant: Guitargate Management, Inc., Baltimore, MD (US)

(72) Inventors: Michael Dalton Palmisano, Baldwin, MD (US); Daniel Robert Caron, New Braintree, MA (US); Matthew Grant Ware Grasmick, Severna Park, MD (US)

(73) Assignee: Guitargate Management, Inc., Baltimore, MD (US)

(21) Appl. No.: 18/946,777

(22) Filed: Nov. 13, 2024

(51) Int. Cl. G10H 1/00; G06F 3/16

(52) U.S. Cl. CPC G10H 1/0033; G06F 3/165; G06F 3/167

(57) ABSTRACT

Devices, systems, methods to record, share, and/or otherwise manage user-generated music content are described herein. A device may be configured to communicate with a remote server hosting a computer application for music sharing, collaboration, and/or social networking. The device may have a form factor of a foot-operated pedal device and/or may have other form factors (e.g., tabletop device, hand-operated device, and/or other form factors). User-generated music content recorded to a device may be transmitted to the remote server and made available for download by other users through the computer application. Control of a device and/or sharing requests (e.g., requests for uploading and/or downloading user-generated music content) may be effectuated through a client computing platform executing an instance of the computer application.

### FIELD OF THE DISCLOSURE

The present disclosure relates to signal processing devices, and systems for recording and/or sharing user-generated music content.

### BACKGROUND

A looper pedal is a type of signal processing device that allows musicians to record and/or play back musical content (e.g., phrases, loops, and/or stems). Looper pedals are typically used with string instruments such as guitars and bass guitars, but may be used with other types of instruments (e.g., keyboards and synthesizers, vocals, drums and/or other percussion instruments, wind instruments, MIDI machines, and/or other instruments). Users may record musical content with a looper pedal by pressing a footswitch. Once recorded, a user may record additional musical content as layers on top of previously recorded content. Some pedals have controls for loop length, undo/redo functions, and/or built-in effects. Looper pedals may be used for practice, songwriting, and/or live performance, allowing musicians to explore their creativity and build dynamic compositions.

### SUMMARY

Traditional signal processing devices used by musicians, such as looper pedals, store recorded musical content (referred to herein as “user-generated music content”) locally on the devices. This limits the playback and enjoyment of the user-generated music content to users who are physically present at the same location as the devices. Oftentimes, collaboration between musicians may be done asynchronously and/or with musicians located in different geographical locations. In these scenarios, implementation of these otherwise convenient and useful pedal devices is not possible.

To address these and/or other problems, one or more implementations presented herein propose devices, systems, and/or methods for recording and/or sharing user-generated music content. A device may be configured to manage user-generated music content. A device may have a form factor of a foot-operated pedal device and/or may have other form factors (e.g., tabletop device, hand-operated device, and/or other form factors). Such a device may be referred to herein as a “music content management device” and/or “pedal device.” Although the device may be referred to as a “pedal” device, this is for illustrative purposes only, as other form factors are contemplated.

A device may be specially configured so that it falls within a category of the “Internet-Of-Things” (IoT). The Internet-Of-Things (IoT) describes, generally, a network of physical devices embedded with software, hardware, and/or other technologies for the purpose of connecting and/or exchanging information with other devices and/or systems over the Internet and/or other networks.

A device may be configured to communicate with a remote server hosting a computer application for music sharing, collaboration, and/or social networking. User-generated music content recorded to a device may be transmitted to the remote server and made available for download by other users through the computer application. Control of a device and/or sharing requests (e.g., requests for uploading and/or downloading user-generated music content) may be effectuated through a client computing platform executing an instance of the computer application. The client computing platform may communicate with a device directly (e.g., peer-to-peer communication), and/or through the remote server.

One or more implementations of a device configured to manage user-generated music content may include one or more of a transceiver configured to transmit and/or receive information over one or more networks, one or more physical input devices (e.g., foot switches, knobs, touchscreen, etc.), one or more displays, one or more ports configured to facilitate electrical coupling with one or more instruments, non-transitory electronic storage, one or more processors, and/or other components. Executing the machine-readable instructions may cause the one or more processors to facilitate recording and/or sharing of user-generated music content as described herein. The machine-readable instructions may include one or more computer program components. The one or more computer program components may include one or more of an input component, a sharing component, and/or other components.

The input component may be configured to obtain, via the one or more ports, one or more audio signals and/or other information. The input component may be configured to generate, from the one or more audio signals and/or other information, music content information defining user-generated music content. The input component may be configured to effectuate storage of the music content information in the non-transitory electronic storage.

The sharing component may be configured to establish one or more network connections with a remote server and/or other entities. The sharing component may be configured to obtain, from the remote server via the transceiver, control information and/or other information. The control information may dictate control instructions for the device.

In response to obtaining the control information, the sharing component may be configured to effectuate communication of the music content information to the remote server over the one or more network connections.

One or more implementations of a system configured to manage user-generated music content may include one or more of server(s), one or more music content management devices, one or more client computing platforms, and/or other components. The server(s) may include one or more of processor(s), non-transitory electronic storage, and/or other components. Executing the machine-readable instructions may cause the processor(s) to facilitate recording and/or sharing user-generated music content as described herein. The machine-readable instructions may include one or more computer program components. The one or more computer program components may include one or more of a user interface component, a communication component, an application component, and/or other components.

The user interface component may be configured to effectuate presentation of graphical user interfaces in instances of a computer application executed on client computing platforms associated with users. The graphical user interfaces may be configured to obtain user input conveying requests to upload user-generated music content stored at music content management devices associated with the users, download user-generated music content stored at server(s) to music content management devices, and/or provide other features and/or functionality. By way of non-limiting illustration, a first graphical user interface may be presented in a first instance of the computer application executed on a first client computing platform associated with a first user.

The communication component may be configured to obtain, from the first client computing platform, user input information conveying first user input. The first user input may comprise a first request to upload first user-generated music content stored at a first music content management device to the non-transitory electronic storage of the server(s).

The communication component may be configured to, in response to obtaining the user input information, effectuate communication of control instructions to the first music content management device. The control instructions may instruct an upload of the first user-generated music content from the first music content management device to the non-transitory electronic storage of the server(s) and/or other instructions.

The communication component may be configured to obtain, from the first music content management device, first music content information defining the first user-generated music content. The communication component may be configured to effectuate storage of the first music content information in the non-transitory electronic storage of the server(s).

The application component may be configured to manage music content information maintaining user-generated music content stored in the non-transitory electronic storage of the server(s). In some implementations, managing music content information may include managing music content feeds presented in the graphical user interfaces in the instances of the computer application and/or other operations. The music content feeds may provide a source from which users may initiate requests to download user-generated music content to their respective music content management devices. In some implementations, the music content feeds may be part of social networking feature(s) provided by the computer application.

As used herein, any association (or relation, or reflection, or indication, or correspondence) involving devices, servers, processors, client computing platforms, and/or another entity or object that interacts with any part of the system and/or plays a part in the operation of the system, may be a one-to-one association, a one-to-many association, a many-to-one association, and/or a many-to-many association or N-to-M association (note that N and M may be different numbers greater than 1). As used herein, the phrase “configured to” is intended to be interpreted broadly, as “being capable of or suitable for performing” some function or feature, without requiring any adaptations to provide said function or feature.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to record and/or share user-generated music content, in accordance with one or more implementations.

FIG. 2 illustrates a method to manage user-generated music content, in accordance with one or more implementations.

FIG. 3 illustrates a music content management device, in accordance with one or more implementations.

FIG. 4 illustrates a client computing platform displaying a pedal device page of a graphical user interface, in accordance with one or more implementations.

FIG. 5 illustrates a client computing platform displaying a user profile page of a graphical user interface, in accordance with one or more implementations.

FIG. 6 illustrates a client computing platform displaying a music content feed page of a graphical user interface, in accordance with one or more implementations.

### DETAILED DESCRIPTION

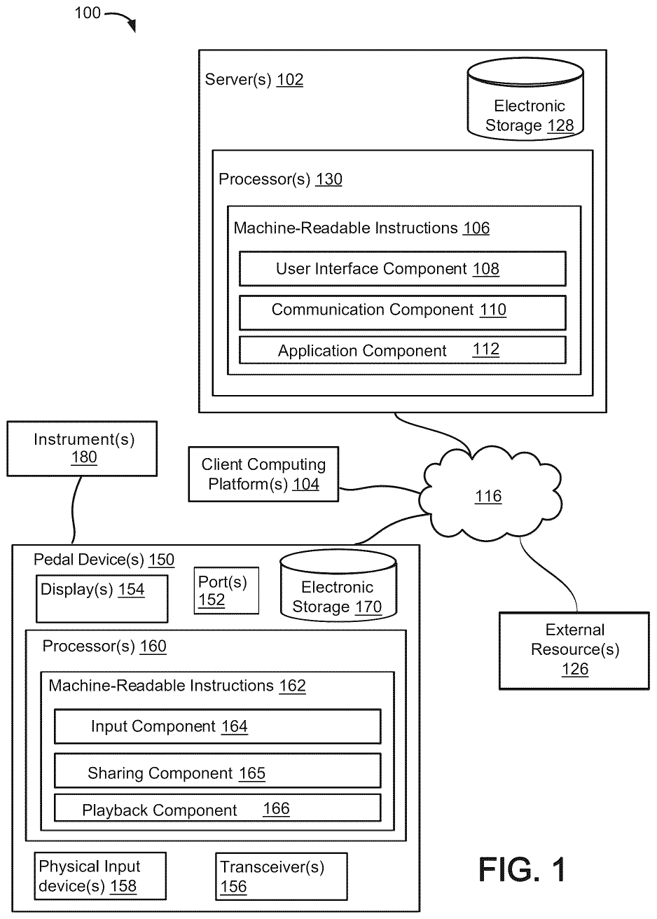

FIG. 1 illustrates a system 100 configured to record and/or share user-generated music content, in accordance with one or more implementations. The system 100 may take advantage of the Internet-Of-Things concept by specially configuring a device (referred to as a “pedal device” and/or “music content management device”) to record music content, upload music content, and/or download music content leveraging network connections between the device, one or more client computing platforms, remote server(s), and/or other components. By way of non-limiting illustration, user-generated music content recorded on one device may be uploaded to a server, and made available for another user to download to their device. These and/or other features of the present disclosure may allow asynchronous collaboration in ways that was not possible with traditional foot-operated looper pedals.

User-generated music content may refer to audio configured for repeated playback, typically referred to as “loops.” The audio may include one or more of a musical phrase, a stem, a musical arrangement (e.g., complete song), and/or other content. A musical phrase may represent a coherent musical segment, typically consisting of several notes that form a self-contained musical expression. Phrases are often used to build melodies. A phrase may be structured with one or more of a beginning, middle, and/or end. A stem may refer to a distinct audio track. A stem may encompass elements such one or more of riffs, beats, hooks, chords, melodies, licks, grooves, baselines, intros, outros, breakdown, fills, sections of a song, and/or other elements. In some implementations, a phrase may exist within a stem such that stem may be a recording of a musical phrase. A musical arrangement may refer to an organization of one or more stems and/or one or more phrases that forms a song.

In some implementations, system 100 may include one or more of server(s) 102, pedal device(s) 150, client computing platform(s) 104, external resource(s) 126, and/or other components. Server(s) 102 may be configured to communicate with pedal device(s) 150, client computing platform(s) 104, external resource(s) 126, and/or other entities of system 100 according to a client/server architecture and/or other architectures. Client computing platform(s) 104 may be configured to communicate with other client computing platforms via server(s) 102 and/or according to a peer-to-peer architecture and/or other architectures. Client computing platform(s) 104 may be configured to communicate with pedal device(s) 150 via server(s) 102 and/or according to a peer-to-peer architecture and/or other architectures. Users may access system 100 and/or associated features and/or functionality via client computing platform(s) 104 and/or pedal device(s) 150. Server(s) 102 may be remote from client computing platform(s) 104 and/or pedal device(s) 150. Client computing platform(s) 104 may be remote from each other and/or pedal device(s) 150. Client computing platform(s) 104 in FIG. 1 may represent an individual client computing platform and/or a set of similarly configured client computing platforms. Pedal device(s) 150 in FIG. 1 may represent an individual pedal device and/or a set of similarly configured pedal devices.

Pedal device(s) 150 may include one or more of port(s) 152, display(s) 154, transceiver(s) 156, physical input device(s) 158, processor(s) 160 configured by machine-readable instructions 162, non-transitory electronic storage 170, power supply (not shown in FIG. 1), and/or other components. Power supply may be local power supply (e.g., onboard batteries) and/or external power supply (e.g., AC adaptor for plug-in power). The non-transitory electronic storage 170 may store one or more of machine-readable instructions 162, information defining user-generated music content, and/or other information that enables pedal device(s) 150 to operate as described herein. Transceiver(s) 156 may enable the exchange of information with network(s) 116, other pedal devices, individual client computing platforms, and/or other entities of system 100. By way of non-limiting illustration, transceiver(s) 156 may generate electrical signals carrying information, send and/or receive electrical signals via one or more antennas (not shown in FIG. 1) which converts electrical signals into radio waves (and vice versa), and/or perform other operations.

Pedal device(s) 150 may be configured to electrically couple to one or more instruments 180 and/or other devices. Pedal device(s) 150 may electrically couple with an individual instrument through port(s) 152. A port may comprise an input jack configure to receive an end of an instrument cable (e.g., standard ¼-inch instrument cable). An other end of the instrument cable may plug into an instrument. In some implementations, another port may comprise an output jack configure to receive an end of another instrument cable (e.g., standard ¼-inch instrument cable) that connects to one or more of an amplifier, headphones, computer, PA system, DAW (Digital Audio Workstation), and/or other output and/or intermediary device (not shown in FIG. 1). In some implementations, pedal device(s) 150 may electrically couple with an individual instrument wirelessly. By way of non-limiting illustration, an instrument may include a wireless transmitter configured to send wireless signals to a pedal device. A transceiver of a pedal device may be configured to receive and/or process signals received from instruments. By way of non-limiting illustration, an instrument transmitter may convert an audio signal into a radio frequency signal, which is then transmitted wirelessly. A receiver at a pedal device may pick up this radio signal and converts it back into an audio signal.

It is noted that although descriptions herein may be directed to “instruments” as a source of audio, this is for illustrative purposes only and not to be considered limiting. Instead, those skilled in the art may recognize that the features and/or functionality presented herein may be applied to other sources of audio and/or devices that may produce audio signals. For example, other sources may include one or more of microphones, existing audio files (e.g., which store audio signals in a digital format), speaker/amplifier outputs, and/or other sources of audio.

Display(s) 154 may be configured to present visual content. The visual content may include one or more of individual images, image sequences, video, text, and/or other content. Presentation via display(s) 154 may be facilitated by a graphics processing unit (GPU) and/or other components. Display(s) 154 may include one or more of screen, a touchscreen, a monitor, a head-mounted display, and/or other displays.

Physical input device(s) 158 may be configured to effectuate various operations of pedal device(s) 150. Physical input devices may include one or more of switch(es) (e.g., foot-operated switches, hand-operated switches), control knob(s), touchscreen, and/or other devices. A switch may be used for various functionality including one or more of start recording, stop recording, playback recorded content, undo/redo an operation, clear/erase recorded content, and/or other functionality. A control knob may be used for various functionality such as output volume control, gain/drive, recording length, tempo/speed, effect/mode selection, switch functionality adjustment, and/or other functionality.

In some implementations, an individual switch may be configured to have one or more activation states. Individual activation states may correspond to one or more functions of the pedal device(s) 150. By way of non-limiting illustration, activation state(s) may include one or more of an engaged state, a released state, and/or other states. The engaged state may correspond to a press activation of the switch. The released state may correspond to a release activation of the switch, e.g., a release following a press of the switch. In some implementations, an engaged state may initiate one or more of a start recording functionality, a stop recording functionality, and/or other functionality. In some implementations, a released state may be configured to be devoid of functionality (e.g., does not cause functionality to be initiated and/or ceased). This configuration may provide advances over traditional pedal devices where the starting and/or stopping of recording happens on a release activation of a switch. This traditional configuration may be problematic, especially when a user is relying on timing and intuition when recording. Accordingly, a configuration proposed by the present disclosure may take out the luck that many musicians rely on when trying to get audio recorded in time because a press activation may be more intuitive and/or reliable.

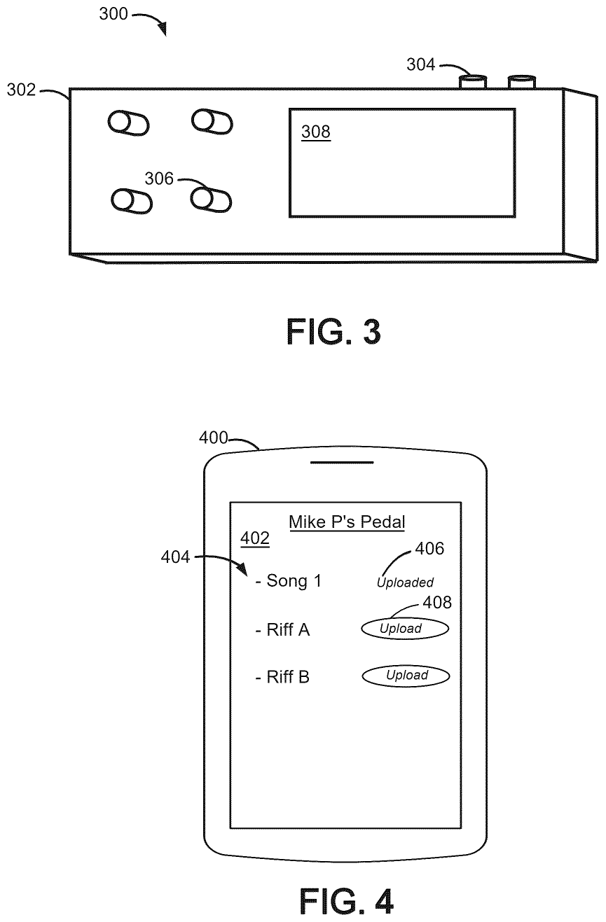

FIG. 3 illustrates a music content management device 300 (e.g., pedal device), in accordance with one or more implementations. The device 300 may take the form of a foot-operated pedal device, and/or may have other form factors. Device 300 may comprise one or more of a housing 302, one or more ports 304, one or more physical input devices 306, a display 308, one or more electronic components housed within housing 302, and/or other components. One or more physical input devices 306 may include one or more of a switch, a knob, and/or other components. The one or more ports 304 may include one or more of an input jack, an output jack, and/or other components. The display 308 may comprise an LCD display, touchscreen display, and/or other display. The housing 302 may comprise a box or other container suitable for housing a volume sized and dimensioned to enclose the various electronic components described herein. The housing 302 may be formed from material suitable for the intended purpose, for example, metal, plastic, and/or other materials.

Returning to FIG. 1, machine-readable instructions 162 may include one or more instruction components. The instruction components may include computer program components. Executing the machine-readable instructions 162 may cause pedal device(s) 150 to facilitate recording and/or sharing user-generated music content. The computer program components may include one or more of an input component 164, a sharing component 165, a playback component 166, and/or other components.

The input component 164 may be configured to obtain one or more audio signals and/or other information. Audio signals may be received from instrument(s) 180 via port(s) 152 and/or other mechanisms. Audio signals may include analog electrical signals and/or other signals. Analog electrical signals may be generated by one or more transducers (e.g., pickups) and/or other technology employed on an instrument. An audio signal may carry several types of information that describe the sound being produced. By way of non-limiting illustration, a signal may contain one or more of amplitude which represents the loudness of the sound, frequency refers to the pitch of the sound, a waveform, a duration of the sound, a phase or the position of the wave in its cycle at a given time, a dynamic range measuring a difference between the quietest and loudest parts of the signal, and/or other information. The audio signal(s) may represent user-generated music content generated via one or more instruments.

The input component 164 may be configured to generate, from one or more audio signals and/or other information, music content information defining user-generated music content represented by the audio signal(s). Generating the music content information from one or more audio signals may include performing Analog to Digital Conversion (ADC) and/or other signal processing techniques. Analog-to-Digital Conversion (ADC) may refer to the process by which an analog audio signal, such as the one generated by a guitar, is transformed into a digital format that can be processed by the pedal device(s) 150. The process may include sampling an audio signal at regular intervals, known as the sampling rate, which may capture amplitude values of the signal over time. The sampled values may then be quantized, e.g., converted into discrete digital values based on a specific bit depth. This quantized information may then be encoded into a binary format for storage, allowing a device to manage the user-generated music content. In some implementations, when playing back user-generated music content (see, e.g., playback component 166), a Digital-to-Analog Converter (DAC) process may reverse the process, turning the digital information back into an analog signal so that it can be played through an amplifier (not shown in FIG. 1).

The input component 164 may be configured to effectuate storage of music content information and/or other information in the non-transitory electronic storage 170.

In some implementations, generating music content information defining user-generated music content represented by audio signal(s) by input component 164 may be based on one or more timing corrections. Timing corrections, often referred to as quantizing and/or time quantization, may cause a timing of user-generated music content to align it with a set grid, or rhythm, to ensure that the user-generated music content is synchronized with a consistent time signature and/or tempo. The grid may be manifested by an audible queue, such as a metronome and/or percussion beat (e.g., a drum track). However, in some implementations, timing correction(s) may be effectuated without an audible queue. In general, when recording user-generated music content, timing correction(s) may “snap” a beginning and/or end of a recording to a beat or subdivision of a tempo, whether or not the user started and/or ended playing exactly on the beat.

In some implementations, a grid may be selected from a group of available grids (e.g., various time signatures and/or tempos), and/or determined dynamically. By way of non-limiting illustration, input component 164 may be configured to identify, based on one or more audio signals representing user-generated music content, a time signature and/or tempo associated with the user-generated music content. In other words, a user's intended time signature and/or tempo may be identified (either initially and/or over the course of generation of the user-generated music content), and used to define a grid to which timing correction(s) may be effectuated.

The sharing component 165 may be configured to facilitate features and/or functionality of uploading and/or downloading user-generated music content within the field of IoT devices. As is described herein, requests for uploading and/or download may be initiated through client computing platform(s) 104, which send commands to server(s) 102 which are relayed to pedal device(s) 150 to effectuate various control functionalities. By way of non-limiting illustration, sharing component 165 may be configured to facilitate establish one or more network connections with server(s) 102 and/or other entities of system 100 (e.g., client computing platform(s) 104, other pedal devices, external resource(s) 126). For example, an electronic communication link between pedal device(s) 160 and server(s) 102 may be established by transceiver(s) 156 via network(s) 116.

The sharing component 165 may be configured to obtain, from the server(s) 102 via transceiver(s) 156, control information and/or other information. The control information may dictate control instructions for pedal device(s) 150. Server(s) 102 may obtain and/or generate the control information based on user interaction with graphical user interfaces in instances of a computer application executed on client computing platform(s) 104. In some implementations, control instructions may include one or more of effectuating an upload of music content information defining user-generated music content stored locally at pedal device(s) 150 to server(s) 102, effectuating a download of music content information defining user-generated music content stored at server(s) 102 for storage at pedal device(s), presenting content via display(s) 154, and/or other operations.

In response to obtaining control information including an instruction to effectuate an upload of music content information to server(s) 102, sharing component 165 may be configured to effectuate communication of music content information stored in storage 170 to the server(s) 102 over network(s) 116.

In some implementations, in response to communicating music content information, sharing component 165 may be configured to cause a client computing platform (through which a request for upload was initiated) to display a notification that music content information has been communicated to server(s) 102. By way of non-limiting illustration, sharing component 165 may be configured to obtain, from server(s) 102, an indication that music content information has been received by server(s) 102, and/or send a report to server(s) 102 the communication of music content information has completed. In response, server(s) 102 may be configured to effectuate communication of a notification to a client computing platform for presentation thereon.

In response to obtaining the control information including an instruction to effectuate a download of music content information from server(s) 102, sharing component 165 may be configured to obtain, from server(s) 102, music content information defining user-generated music content stored in non-transitory electronic storage 128. Sharing component 165 may be configured to effectuate storage of the obtained music content information in the non-transitory electronic storage 170. This allows users to download other users'music content directly to their pedal devices, and play back that content as if it was originally recorded to their pedal devices.

In some implementations, in response to storing obtained music content information, sharing component 165 may be configured to cause a client computing platform (through which a request for download was initiated) to display a notification that music content information has been stored in the non-transitory electronic storage 170. By way of non-limiting illustration, sharing component 165 may be configured to report back to server(s) 102 that music content information was successfully obtained and/or stored, and in response server(s) 102 may be configured to effectuate communication of a notification to a client computing platform for presentation thereon.

The playback component 166 may be configured to effectuate presentation (e.g., playback) of user-generated music content. In some implementations, playback may be facilitated based on music content information stored in non-transitory electronic storage 170, and/or music content information received from server(s) 102. In some implementations, playback may be facilitated based on music content information stored in non-transitory electronic storage 170 by performing a DAC process and/or other processes. In some implementations, playback may be facilitated based on music content information received from server(s) 102 as it is received from server(s) 102 so that user-generated music content is essentially being streamed from server(s) 102 to pedal device(s) 150 for simultaneous (or near simultaneous) playback. Playback may be provided via one or more of an amplifier, headphones, and/or other playback devices (not shown in FIG. 1) coupled to pedal device(s) 150.

In some implementations, playback component 166 may be configured to obtain requests to present user-generated music content. In some implementations, requests for playback may be initiated from user input into a graphical user interface presented at a client computing platform. In some implementations, requests for playback may be initiated from user interaction with physical input device(s) 158 on pedal device(s) 150).

In some implementations, sharing component 165 may be configured to communicate identifications of stored music content information to server(s) 102. In some implementations, sharing component 165 may be configured to communicate identifications of stored music content information to server(s) 102 periodically and/or based on user requests. Identifications of stored music content information may include identification(s) of music content information stored in storage 170 of pedal device(s) 150 but not yet uploaded to server(s) 102. The identification may include serial numbers, dates when recorded to pedal device(s) 150, information stated by users (e.g., input via a touchscreen), and/or other identifying information. Server(s) 102 may utilize this information to compile pages (e.g., “pedal device pages”) of the graphical user interfaces that display lists of the user-generated music content stored on respective pedal devices which may be available for upload to server(s) 102. As described in more detail herein, users may initiate requests to upload user-generated music content through interaction in the pedal device pages in the graphical user interfaces of the computer application.

By way of non-limiting illustration of a scenario where user-generated music content is downloaded and played back with user-generated music content already recorded on stored locally at a device, the input component 164 of a first music content management device (e.g., pedal device) associated with a first user may be configured to obtain, via one or more ports, a set of audio signals and/or other information. The input component 164 may be configured to generate, from the set of audio signals and/or other information, first music content information defining first user-generated music content. The input component 164 may be configured to effectuate storage of the first music content information in the non-transitory electronic storage 170. The sharing component 165 may be configured to obtain, from server(s) 102, second music content information defining second user-generated music content that is stored in electronic storage 128 of server(s) 128. The sharing component 165 may be configured to effectuate storage of the second music content information in the non-transitory electronic storage 170. The playback component 166 of the first music content management device may be configured to obtain a first request to present the first user-generated music content, a second request to present the second user-generated music content, and/or other request. In some implementations, the first request may be a request to present the first user-generated music content and the second user-generated music content. The playback component 166 may be configured to effectuate presentation of the first user-generated music content concurrently with the second user-generated music content and/or other user-generated music content.

By way of non-limiting illustration of a scenario where locally stored user-generated music is uploaded for sharing, the sharing component 65 of the first music content management device may be configured to obtain, from server(s) 102, control information dictating a control instruction for the first music content management device to upload the first music content information. In response to obtaining the control information, sharing component 165 may be configured to effectuate communication of the first music content information to server(s) 102 over the one or more network connections. The server(s) 102 may store the first music content information in electronic storage 128. Thus, the first user-generated music content defined by the first music content information may be made available for download by other users to other pedal devices.

Referring now to further sharing, collaboration, and/or social networking functionality, server(s) 102 may include one or more of non-transitory electronic storage 128, one or more processors 130 configured by machine-readable instructions 106, and/or other components. The non-transitory electronic storage 128 may store one or more of machine-readable instructions 106, music content information, application state information, and/or other information. Machine-readable instructions 106 may include one or more instruction components. The instruction components may include computer program components. Executing the machine-readable instructions 106 may cause server(s) 102 to facilitate recording and/or sharing of user-generated music content. The computer program components may include one or more of a user interface component 108, a communication component 110, an application component 112, and/or other components.

Application component 112 may be configured to manage application state information and/or other information used in maintaining a computer application for user-generated music content sharing, collaboration, and/or social networking. The computer application may be configured to facilitate interaction by users with user-generated music content and/or each other in a social network. The application state information may include one or more of user profiles associated with users, music content information, one or more pages of the graphical user interfaces, and/or other information.

The user profiles may include user information describing users of the computer application. The user information in the user profiles may include values of user parameters and/or other information. The values of the user parameters may be organized in the user profiles corresponding to users interacting with and/or viewing the computer application. The values of the user parameters may include information describing and/or identifying the users, their activity within computer application, their settings, metadata associated with the users, pedal device(s) associated with the users (e.g., registered by the users), and/or other user information. Individual ones of the users may be associated with individual ones of the user profiles. A user profile may define values of the user parameters associated with a given user.

The values of the user parameters may, by way of non-limiting example, specify one or more of: a user name, identification of registered pedal device(s), an email address, a photo, one or more user comments, one or more groups or teams the user belongs to, user-generated music content associated with a user, one or more interaction parameters (e.g., indicating a user is working on/worked on user-generated music content, indicating a user has uploaded and/or downloaded certain user-generated music content, indicating a user has viewed another user profile, a timeframe a given user last interacted with the computer application, and/or other interaction parameters), one or more notification settings, status information for user-generated music content (e.g., user-generated music content the user has uploaded, user-generated music content the user had downloaded, user-generated music content that is in the process of downloading, user-generated music content that is in the process of uploading, and/or other status information), one or more collaboration metrics of a given user (e.g., how many other users the user has collaborated with), application access information (e.g., username/password), and/or other information.

In some implementations, managing music content information may include one or more of obtaining music content information from music content management devices (e.g., pedal device(s) 150), managing music content feeds presented in graphical user interfaces in instances of a computer application, distributing the music content information to the music content management devices, and/or other operations. The music content feeds may be presented to the users in the graphical user interfaces to facilitate access to the user-generated music content stored in electronic storage 128. Individual feeds may represent user-generated music content that may be available for individual users to download. Feeds may be established by making connections with other users within the computer application. Such connections may refer to social networking features such as being friends, followers, patrons, members, and/or other considerations. By way of non-limiting illustration, a user may make social connections with a set of other users via the computer application, so that the feed presented in a graphical user interface on a client computing platform associated with the user may display the user-generated music content associated with the set of other users (e.g., user-generated music content that the set of other users have uploaded to server(s) 102).

The user interface component 108 may be configured to effectuate presentation of graphical user interfaces in instances of a computer application executed on client computing platform(s) 104 of the users. The graphical user interface may provide views of one or more of music content feeds (e.g., feed pages), user profile pages, pedal device pages, social networking pages, and/or provide other features and/or functionality. In some implementations, an individual view may include text, graphics, pictures, videos, and/or other content. The graphical user interface may include one or more user interface elements configured to facilitate user interaction with the graphical user interface. By way of non-limiting illustration, user interface elements may include one or more of text input fields, drop-down menus, check boxes, display windows, virtual buttons, icons, panes, tabs, scrollbars, and/or other elements configured to facilitate user interaction with a graphical user interface.

Effectuating presentation of a graphical user interface may include one or more of generating user interface information defining the graphical user interface, communicating the user interface information to client computing platform(s) 104 over network(s) 116, and/or other operations. Individual client computing platform(s) 104 may receive the user interface information. Reception of the user interface information may cause the client computing platform(s) 104 to present instances of the graphical user interface.

In some implementations, the graphical user interface may be configured to receive user input at the client computing platform(s) 104. The user input may include one or more of selection of individual user interface elements, text entry, and/or other input. In some implementations, user interface component 108 may be configured to effectuate presentation of graphical user interfaces in instances of a computer application through which the users generate requests to share user-generated music content. The requests to share user-generated music content may include one or more of upload requests (e.g., send information from pedal device(s) 150 to server(s) 102), download requests (e.g., send information from server(s) 102 to pedal device(s) 150), and/or other requests.

The graphical user interface may include one or more user interface elements through which users may input text, select graphical icons, and/or perform other interactions as part of generating one or more requests and/or performing other operations. By way of non-limiting illustration, the graphical user interface may include a selectable user interface element (e.g., virtual button) appearing near a representation of user-generated music content (e.g., a name of the content, a date when created, and/or other identifying information) through which a user initiates a request to download and/or upload the user-generated music content.

The communication component 110 may be configured to obtain and/or generate user input information conveying user input within the instances of the graphical user interface at the client computing platform(s) 104. The user input information may be stored in non-transitory electronic storage 128 and/or other storage locations. In some implementations, interactions at the client computing platforms 104 comprising user input (e.g., clickstreams) may be communicated to communication component 110 such that communication component 110 may generate the user input information. In some implementations, individual client computing platforms may generate the user input information based on the user entry and/or selection at the client computing platform(s) 104 and communicate the user input information to the communication component 110.

In some implementations, user profiles may be accessed through profile pages in the graphical user interfaces. The profile pages may provide access to user-generated music content associated with the users and/or stored in the non-transitory electronic storage 128. “Access” may refer to functionality one or more of viewing available user-generated music content, requesting a download of user-generated music content, and/or other functionality. In some implementations, users may name/rename user-generated music content through profile pages and/or other pages. By way of non-limiting illustration, the user profiles may include a first user profile of the first user. The first user profile may be accessed through a first profile page. The first profile page may provide access to the first music content information and/or other information stored in the non-transitory electronic storage 128.

Individual feeds may be presented in a graphical user interface in feed pages of the graphical user interface. The feed pages may provide another mechanism for access to user-generated music content associated with the users and/or stored in the non-transitory electronic storage 128. Individual feed pages may display a set of feed items. An individual feed item may correspond to one or more of an individual piece of user-generated music content, an individual user, and/or other considerations. A feed item corresponding to an individual user may display a set of one or more user-generated music content associated with the user (e.g., the same as or similar to what would appear in a profile page for that user). Individual feed pages may be presented based on one or more spatial arrangements. The spatial arrangements may include one or more of a list view, a board view, and/or other views. The list view may include a vertical arrangement of feed items representing user-generated music content through which feed items may be scrolled to. The board view may include a grid of feed items arranged in columns and/or rows.

Individual pedal device pages may display lists of user-generated music content stored at individual pedal devices. Pedal device pages may include one or more user interface elements through which users provide input to initiate requests to upload user-generated music content from pedal device(s) 150 to server(s) 102. In some implementations, users may name/rename user-generated music content through pedal pages and/or other pages. By way of non-limiting illustration, user-generated music content stored on a pedal device may be identified in a pedal device page associated with the pedal device, with virtual buttons appearing near and/or in association with identifying information for user-generated music content. Selection of a virtual button may initiate a request to upload corresponding user-generated music content.

Social networking pages may include one or more pages through which social networking functionality and/or other functionality may be carried out. By way of non-limiting illustration, social network pages may provide features and/or functions to manage user connections, view content posted by users, publicly communicate (e.g., in message boards, chat rooms, public feeds), privately communicate (e.g., direct messaging), control privacy settings, receive notifications, utilize search tools for discovering other users and/or content, and/or other features and/or functions. In some implementations, feed pages may be part of, and/or subsets of, one or more social networking pages. In some implementations, feed pages may include some social networking functionality such as private and/or public communication.

The user interface component 108 may be configured to, responsive to obtaining user input, cause a graphical user interface to navigate to between pages and/or other views, and/or perform other actions. In some implementations, navigating to pages may include one or more of presenting a new user interface, displaying a user interface portion, presenting a pop-up window, and/or other navigation that leads to presentation of one or more pages.

By way of non-limiting illustration of an upload process, server(s) 102 may be configured to establish a first network connection with a first client computing platform associated with the first user. The user interface component 108 may be configured to effectuate presentation of a first graphical user interface in a first instance of the computer application executed on the first client computing platform associated with the first user. The communication component 110 may be configured to obtain, from the first client computing platform, user input information conveying first user input by the first user in the first graphical user interface. The first user input may comprise a first request to upload the first user-generated music content stored at the first music content management device to the non-transitory electronic storage 128 of the server(s) 102. In some implementations, the first user input may be associated with input on a pedal device page associated with the first music content management device.

The server(s) 102 may be configured to establish a second network connection with the first music content management device. The communication component 110 may be configured to, in response to obtaining the user input information, effectuate communication of control information to the first music content management device. The control information may dictate the control instruction for the first music content management device to upload the first music content information. The communication component 110 may be configured to obtain, from the first music content management device, the first music content information defining the first user-generated music content. The communication component 110 may be configured to effectuate storage of the first music content information in the non-transitory electronic storage 128. In some implementations, user interface component 108 may be configured to cause the first graphical user interface to present a notification that the first user-generated music content has been uploaded to the non-transitory electronic storage 128.

By way of non-limiting illustration of a download process, non-transitory electronic storage 128 may further store the second music content information defining second user-generated music content uploaded by a second user. The communication component 110 may be configured to obtain, from the first client computing platform, user input information conveying second user input. The second user input may comprise a second request to download the second user-generated music content to the first music content management device. The second user input may be input made on one or more of a feed page, profile page of the second user, and/or other views of the graphical user interface. By way of non-limiting illustration, a first music content feed may be presented within a first feed page in the first graphical user interface presented in the first instance of the computer application executed on the first client computing platform associated with the first user. The first music content feed may display a set of user-generated music content available for selection by the first user. The second user input may comprise a selection of the second user-generated music content (e.g., selection of a virtual button) from the set of user-generated music content displayed in the first music content feed.

In response to obtaining the second user input, communication component 110 may be configured to effectuate communication of an instance of the second music content information to the first music content management device to cause the first music content management device to store the second music content information. The user interface component 108 may be configured to cause the first graphical user interface to present a notification that the second user-generated music content has been downloaded to the first music content management device.

By way of non-limiting illustration of another download process, communication component 110 may be configured to obtain, from a second client computing platform associated with the second user, second user input information conveying user input in the first profile page. The second user input may comprise a request to download the first user-generated music content to a second music content management device (e.g., second pedal device) associated with the second user. In response to obtaining the user input, communication component 110 may be configured to effectuate communication of an instance of the first music content information to the second music content management device to cause the second music content management device to store an instance of the first music content information. The user interface component 108 may be configured to cause a second graphical user interface presented in a second instance of the computer application executed on the second client computing platform associated with the second user to present a notification that the first user-generated music content has been downloaded to the second music content management device.

FIG. 4 illustrates a client computing platform 400 displaying a pedal device page 402 of a graphical user interface of a computer application for music sharing, collaboration, and/or social networking, in accordance with one or more implementations. The pedal device page 402 may display a list 404 of user-generated music content stored a pedal device. Pedal device page 402 may include one or more user interface elements through which a user provides input to initiate requests to upload user-generated music content from a pedal device to a remote server. The list 404 may show user-generated music content by name, creation date, and/or other identifying information. In some implementations, users may name/rename user-generated music content through the pedal device page 402. Pedal device page 402 may include status identifiers showing status of user-generated music content. By way of non-limiting illustration, virtual buttons (such as virtual button 408) may be presented near and/or in association with identifying information for user-generated music content. Selection of a virtual button may initiate a request to upload corresponding user-generated music content. Pedal device page 402 may include a status indicator 406 showing, for example, that corresponding user-generated music content (“Song 1”) has already been uploaded.

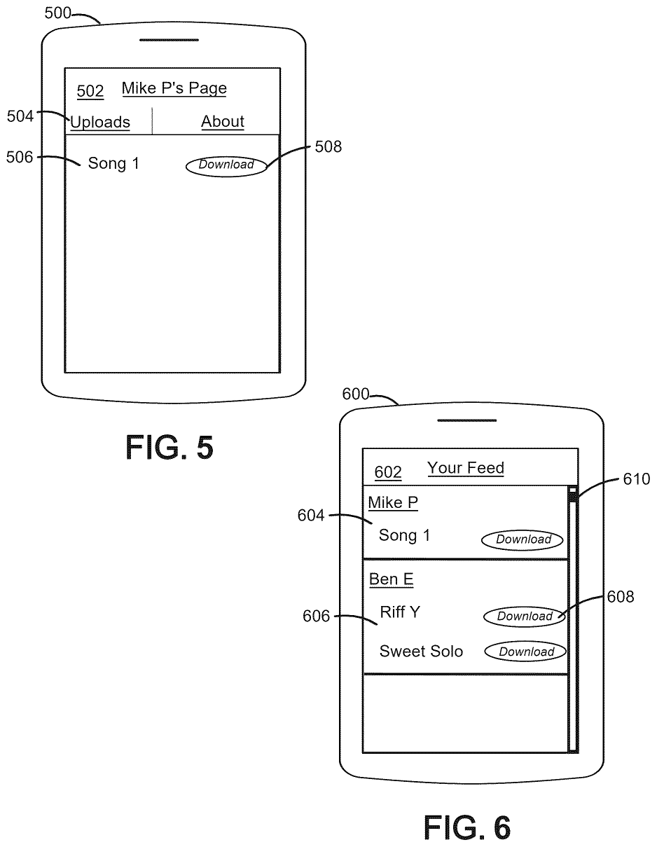

FIG. 5 illustrates a client computing platform 500 displaying a user profile page 502 of a graphical user interface of a computer application for music sharing, collaboration, and/or social networking, in accordance with one or more implementations. The profile page 502 may provide access to user-generated music content associated with a user (“Mike P”) and/or other information. The profile device page 502 may include one or more user interface elements through which a user provides input to initiate requests to download user-generated music content. By way of non-limiting illustration, a tab 504 within profile page 502 may be selected to display a list 506 of user-generated music content uploaded by the user and made available for download by other users. The profile page 502 may include other tabs, sections, panes, and/or other portions (e.g., an “About” page configured to display additional information about user Mike P). The profile page 502 may include virtual buttons (such as virtual button 508) presented near and/or in association with identifying information for user-generated music content. Selection of a virtual button (e.g., virtual button 508) may initiate a request to download corresponding user-generated music content (e.g., “Song 1”).

FIG. 6 illustrates a client computing platform 600 displaying a music content feed page 602 of a graphical user interface of a computer application for music sharing, collaboration, and/or social networking, in accordance with one or more implementations. The feed page 602 may provide a mechanism for access to user-generated music content associated with the users. The feed page 602 may display a set of feed items. An individual feed item may correspond to one or more of an individual piece of user-generated music content, an individual user, and/or other considerations. By way of non-limiting illustration, the feed page 602 may include one or more of a first feed item 604 corresponding to a first user (“Mike P”), a second feed item 606 corresponding to a second user (“Ben E”), and/or other feed items. The feed page 602 may be configured to allow users to scroll through feed items via, for example, a scroll bar 610. A feed item corresponding to an individual user may display a set of one or more user-generated music content associated with the user (e.g., the same as or similar to what would appear in a profile page for that user). The feed items may include virtual buttons (such as virtual button 608) presented near and/or in association with identifying information for user-generated music content. Selection of a virtual button (e.g., virtual button 608) may initiate a request to download corresponding user-generated music content (e.g., “Riff Y”).

FIGS. 3-6 and associated descriptions are provided for illustrative purposes only and are not to be considered limiting. Instead, those skilled in the art may appreciate other device configurations and/or configurations of pages within a graphical user interface that may be provided in order to achieve the features and/or functionally described herein.

Referring back to FIG. 1, in some implementations, server(s) 102, client computing platform(s) 104, pedal device(s) 150, and/or external resource(s) 126 may be operatively linked via one or more electronic communication links. For example, such electronic communication links may be established, at least in part, via network(s) 116 such as the Internet, Bluetooth, NFC, and/or other networks. By way of non-limiting illustration, server(s) 102 and client computing platform(s) 104 may communicate over the Internet; server(s) 102 and pedal device(s) 150 may communicate over the Internet; and client computing platform(s) 104 and pedal device(s) 150 may communicate over Bluetooth. It will be appreciated that this is not intended to be limiting, and that the scope of this disclosure includes implementations in which server(s) 102, pedal device(s) 150, client computing platform(s) 104, and/or external resource(s) 126 may be operatively linked via some other communication media.

External resource(s) 126 may include sources of information outside of system 100, external entities participating with system 100, and/or other resources. In some implementations, some or all of the functionality attributed herein to external resource(s) 126 may be provided by resource(s) included in system 100. In some implementations, an external resource may include a host of user-generated music content (e.g., having audio files of prerecorded music).

A given client computing platform may include one or more processors configured to execute computer program components of machine-readable instructions. The computer program components may be configured to enable a user associated with the given client computing platform to interface with system 100, pedal device(s) 150, and/or external resource(s) 126, and/or provide other functionality attributed herein to client computing platform(s) 104 and/or server(s) 102. By way of non-limiting example, the given client computing platform 104 may include one or more of a desktop computer, a laptop computer, a handheld computer, a tablet computing platform, a NetBook, a Smartphone, a gaming console, and/or other computing platforms.

Server(s) 102 may include electronic storage 128, one or more processors 130, and/or other components. Server(s) 102 may include communication lines, or ports to enable the exchange of information with network(s) 116 and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, a physical processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, and/or other components. Processor(s) 130 may be configured to execute components 108, 110, 112, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, and/or 112 are illustrated in FIG. 1 as being implemented within a single processing unit, in implementations in which processor(s) 130 includes multiple processing units, one or more of components 108, 110, and/or 112 may be implemented remotely from the other components. The description of the functionality provided by the different components 108, 110, and/or 112 described herein is for illustrative purposes, and is not intended to be limiting, as any of components 108, 110, and/or 112 may provide more or less functionality than is described. For example, one or more of components 108, 110, and/or 112 may be eliminated, and some or all of its functionality may be provided by other ones of components 108, 110, and/or 112. As another example, processor(s) 130 may be configured to execute one or more additional components that may perform some or all of the functionality attributed herein to one of components 108, 110, and/or 112.

Pedal device(s) 150 may include communication lines, or ports to enable the exchange of information with network(s) 116, other pedal device, client computing platforms, server(s), and/or other devices. Illustration of pedal device(s) 150 in FIG. 1 is not intended to be limiting.

Electronic storage 170 of pedal device(s) 150 may comprise non-transitory storage media that electronically stores information. The electronic storage media of electronic storage 170 may include one or both of storage that is provided integrally (i.e., substantially non-removable) with pedal device(s) 150 and/or removable storage that is removably connectable to pedal device(s) 150 via, for example, a port (e.g., a USB port, a firewire port, etc.) or a drive (e.g., a disk drive, etc.). Electronic storage 170 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 170 may include one or more virtual storage resources (e.g., cloud storage, a virtual private network, and/or other virtual storage resources). Electronic storage 170 may store software algorithms, information determined by processor(s) 160, information received from server(s) 102, information received from client computing platform(s) 104, and/or other information that enables pedal device(s) 150 to function as described herein.

Processor(s) 160 may be configured to provide information processing capabilities in pedal device(s) 150. As such, processor(s) 160 may include one or more of a digital processor, a physical processor, an analog processor, a digital circuit designed to process information, an analog circuit designed to process information, a state machine, and/or other mechanisms for electronically processing information. Although processor(s) 160 is shown in FIG. 1 as a single entity, this is for illustrative purposes only. In some implementations, processor(s) 160 may include a plurality of processing units. These processing units may be physically located within the same device, or processor(s) 160 may represent processing functionality of a plurality of devices operating in coordination. Processor(s) 160 may be configured to execute components 164, 165, 166, and/or other components. Processor(s) 160 may be configured to execute components 164, 165, 166, and/or other components by software; hardware; firmware; some combination of software, hardware, and/or firmware; and/or other mechanisms for configuring processing capabilities on processor(s) 160. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 164, 165, and/or 166 are illustrated in FIG. 1 as being implemented within a single processing unit, in implementations in which processor(s) 160 includes multiple processing units, one or more of components 164, 165, and/or 166 may be implemented remotely from the other components. The description of the functionality provided by the different components 164, 165, and/or 166 described herein is for illustrative purposes, and is not intended to be limiting, as any of components 164, 165, and/or 166 may provide more or less functionality than is described. For example, one or more of components 164, 165, and/or 166 may be eliminated, and some or all of its functionality may be provided by other ones of components 164, 165, and/or 166. As another example, processor(s) 160 may be configured to execute one or more additional components that may perform some or all of the functionality attributed herein to one of components 164, 165, and/or 166.

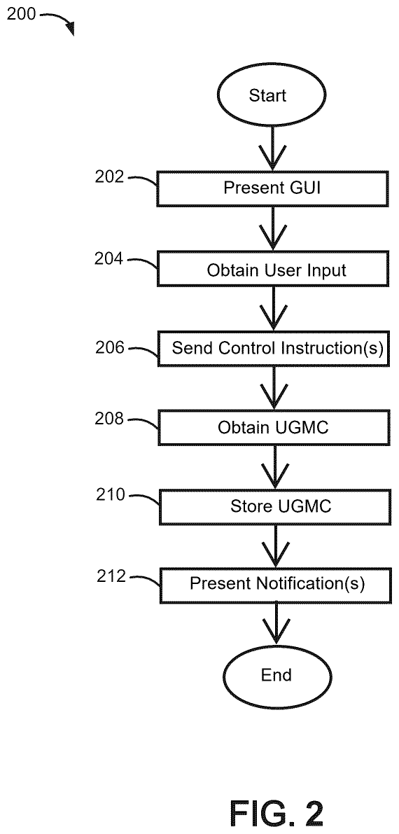

FIG. 2 illustrates a method 200 to manage user-generated music content, in accordance with one or more implementations. The operations of method 200 presented herein are intended to be illustrative. In some implementations, method 200 may be accomplished with one or more additional operations not described, and/or without one or more of the operations discussed. Additionally, the order in which the operations of method 200 are illustrated in FIG. 2 and described herein is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may effectuate presentation of graphical user interfaces in instances of a computer application executed on client computing platforms associated with users. The graphical user interfaces may be configured to obtain user input conveying requests to upload and/or download user-generated music content. The graphical user interfaces may include a first graphical user interface presented in a first instance of the computer application executed on a first client computing platform associated with a first user. Operation 202 may be performed by one or more hardware processors configured by machine-readable instructions including a component that is the same as or similar to user interface component 108 (shown in FIG. 1 and described herein), in accordance with one or more implementations.

An operation 204 may obtain, from the first client computing platform, user input information conveying first user input and/or other information. The first user input may comprise a first request to upload first user-generated music content stored at a first music content management device to non-transitory electronic storage of a remote server. Operation 204 may be performed by one or more hardware processors configured by machine-readable instructions including a component that is the same as or similar to communication component 110 (shown in FIG. 1 and described herein), in accordance with one or more implementations.

An operation 206 may, in response to obtaining user input information, effectuate communication of control instructions to the first music content management device and/or other devices. The control instructions may instruct the upload of the first user-generated music content from the first music content management device to the non-transitory electronic storage. Operation 206 may be performed by one or more hardware processors configured by machine-readable instructions including a component that is the same as or similar to communication component 110 (shown in FIG. 1 and described herein), in accordance with one or more implementations.

An operation 208 may obtain, from the first music content management device, first music content information defining the first user-generated music content. Operation 208 may be performed by one or more hardware processors configured by machine-readable instructions including a component that is the same as or similar to communication component 110 (shown in FIG. 1 and described herein), in accordance with one or more implementations.

An operation 210 may effectuate storage of music content information in the non-transitory electronic storage. Operation 210 may be performed by one or more hardware processors configured by machine-readable instructions including a component that is the same as or similar to model component 112 (shown in FIG. 1 and described herein), in accordance with one or more implementations.

An operation 212 may cause the first graphical user interface to present a notification that the first user-generated music content has been uploaded to the non-transitory electronic storage. Operation 212 may be performed by one or more hardware processors configured by machine-readable instructions including a component that is the same as or similar to communication component 110 (shown in FIG. 1 and described herein), in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed:

1. A device configured to manage user-generated music content, the device comprising:
a transceiver configured to transmit and/or receive information over one or more networks;
one or more physical input devices;
one or more ports configured to facilitate electrical coupling with one or more instruments;
non-transitory electronic storage; and
one or more processors configured by machine-readable instructions to:
obtain, via the one or more ports, one or more audio signals;
generate, from the one or more audio signals, music content information defining user-generated music content;
effectuate storage of the music content information in the non-transitory electronic storage;
establish one or more network connections with a remote server;
obtain, from the remote server via the transceiver, control information dictating control instructions for the device; and
in response to obtaining the control information, effectuate communication of the music content information to the remote server over the one or more network connections.

2. The device of claim 1, wherein the one or more processors are further configured by the machine-readable instructions to:
obtain, from the remote server, second music content information defining second user-generated music content;
effectuate storage of the second music content information in the non-transitory electronic storage; and
cause a client computing platform to display a notification that the second music content information has been stored in the non-transitory electronic storage.

3. The device of claim 2, wherein the one or more processors are further configured by the machine-readable instructions to:
obtain a first request to present the user-generated music content and a second request to present the second user-generated music content; and
effectuate presentation of the user-generated music content concurrently with the second user-generated music content.

4. The device of claim 1, wherein the one or more processors are further configured by the machine-readable instructions to:
obtain, from the remote server, an indication that the music content information has been received by the remote server; and
cause a client computing platform to display a notification that the music content information has been received by the remote server.

5. A system configured to manage user-generated music content, the system comprising:
non-transitory electronic storage; and
one or more processors configured by machine-readable instructions to:
effectuate presentation of graphical user interfaces in instances of a computer application executed on client computing platforms associated with users, the graphical user interfaces being configured to obtain user input conveying requests to upload user-generated music content stored at music content management devices associated with the users, such that a first graphical user interface is presented in a first instance of the computer application executed on a first client computing platform associated with a first user;
obtain, from the first client computing platform, user input information conveying first user input, the first user input comprising a first request to upload first user-generated music content stored at a first music content management device to the non-transitory electronic storage;
in response to obtaining the user input information, effectuate communication of control instructions to the first music content management device, the control instructions instructing the upload of the first user-generated music content from the first music content management device to the non-transitory electronic storage;
obtain, from the first music content management device, first music content information defining the first user-generated music content; and
effectuate storage of the first music content information in the non-transitory electronic storage.

6. The system of claim 5, wherein the one or more processors are further configured by the machine-readable instructions to:
cause the first graphical user interface to present a notification that the first user-generated music content has been uploaded to the non-transitory electronic storage.

7. The system of claim 5, wherein the non-transitory electronic storage stores second music content information defining second user-generated music content, and wherein the one or more processors are further configured by the machine-readable instructions to:
obtain, from the first client computing platform, second user input information conveying second user input, the second user input comprising a second request to download the second user-generated music content to the first music content management device; and
in response to obtaining the second user input information, effectuate communication of an instance of the second music content information to the first music content management device to cause the first music content management device to store the second music content information.

8. The system of claim 7, wherein the one or more processors are further configured by the machine-readable instructions to:
cause the first graphical user interface to present a notification that the second user-generated music content has been downloaded to the first music content management device.

9. The system of claim 7, wherein the one or more physical processors are further configured by the machine-readable instructions to:
manage music content information maintaining the user-generated music content stored in the non-transitory electronic storage, wherein managing the music content information includes obtaining the music content information from the music content management devices, managing music content feeds presented in the graphical user interfaces in the instances of the computer application, and distributing the music content information to the music content management devices;
manage a first music content feed in the first graphical user interface presented in the first instance of the computer application executed on the first client computing platform associated with the first user, the first music content feed displaying a set of user-generated music content available for selection; and
wherein the second user input comprising the second request to download the second user-generated music content to the first music content management device comprises a selection of the second user-generated music content from the set of user-generated music content displayed in the first music content feed.

10. The system of claim 5, wherein the first user-generated music content includes an individual stem, or an arrangement of multiple stems.

11. The system of claim 5, wherein the one or more processors are further configured by the machine-readable instructions to:
establish a first network connection with the first client computing platform; and
establish a second network connection with the first music content management device.

12. The system of claim 5, wherein the one or more processors are further configured by the machine-readable instructions to:
manage user profiles associated with the users, an individual user profile corresponding to an individual user, the user profiles being accessed through profile pages of the graphical user interfaces, wherein the profile pages further provide access to the user-generated music content associated with the users and stored in the non-transitory electronic storage, the user profiles including a first user profile of the first user, the first user profile being accessed through a first profile page, wherein the first profile page provides access to the first music content information stored in the non-transitory electronic storage.

13. The system of claim 12, wherein the one or more processors are further configured by the machine-readable instructions to:
obtain, from a second client computing platform, second user input information conveying second user input in the first profile page, the second user input comprising a second request to download the first user-generated music content to a second music content management device; and
in response to obtaining the second user input information, effectuate communication of an instance of the first music content information to the second music content management device to cause the second music content management device to store the first music content information.

14. The system of claim 13, wherein the one or more processors are further configured by the machine-readable instructions to:
cause a second graphical user interface to present a notification that the first user-generated music content has been downloaded to the second music content management device.

15. A method to manage user-generated music content, the method comprising:
effectuating presentation of graphical user interfaces in instances of a computer application executed on client computing platforms associated with users, the graphical user interfaces being configured to obtain user input conveying requests to upload user-generated music content stored at music content management devices associated with the users, the graphical user interfaces including a first graphical user interface presented in a first instance of the computer application executed on a first client computing platform associated with a first user;
obtaining, from the first client computing platform, user input information conveying first user input, the first user input comprising a first request to upload first user-generated music content stored at a first music content management device to non-transitory electronic storage;
in response to obtaining the user input information, effectuating communication of control instructions to the first music content management device, the control instructions instructing the upload of the first user-generated music content from the first music content management device to the non-transitory electronic storage;
obtaining, from the first music content management device, first music content information defining the first user-generated music content;
effectuating storage of the first music content information in the non-transitory electronic storage; and
causing the first graphical user interface to present a notification that the first user-generated music content has been uploaded to the non-transitory electronic storage.

16. The method of claim 15, further comprising:
obtaining second music content information defining second user-generated music content;
obtaining, from the first client computing platform, second user input information conveying second user input, the second user input comprising a second request to download the second user-generated music content to the first music content management device;
in response to obtaining the second user input information, effectuating communication of an instance of the second music content information to the first music content management device to cause the first music content management device to store the second music content information; and
causing the first graphical user interface to present a second notification that the second user-generated music content has been downloaded to the first music content management device.

17. The method of claim 16, further comprising:
managing music content information maintaining the user-generated music content stored in the non-transitory electronic storage, wherein managing the music content information includes obtaining the music content information from the music content management devices, managing music content feeds presented in the graphical user interfaces in the instances of the computer application, and distributing the music content information to the music content management devices;
managing a first music content feed in the first graphical user interface presented in the first instance of the computer application executed on the first client computing platform associated with the first user, the first music content feed displaying a set of user-generated music content available for selection; and
wherein the second user input comprising the second request to download the second user-generated music content to the first music content management device comprises a selection of the second user-generated music content from the set of user-generated music content displayed in the first music content feed.

18. The method of claim 15, further comprising:
managing user profiles associated with the users, an individual user profile corresponding to an individual user, the user profiles being accessed through profile pages of the graphical user interfaces, wherein the profile pages further provide access to the user-generated music content stored associated with the users and stored in the non-transitory electronic storage, the user profiles including a first user profile of the first user, the first user profile being accessed through a first profile page, wherein the first profile page provides access to the first music content information stored in the non-transitory electronic storage.

19. The method of claim 18, further comprising:
obtaining, from a second client computing platform, second user input information conveying second user input in the first profile page, the second user input comprising a second request to download the first user-generated music content to a second music content management device; and
in response to obtaining the second user input information, effectuating communication of an instance of the first music content information to the second music content management device to cause the second music content management device to store the first music content information.

20. The method of claim 19, further comprising:
causing a second graphical user interface to present a notification that the first user-generated music content has been downloaded to the second music content management device.
